(19) United States
(12) Patent Application Publication
(10) Pub. No.: US 2006/0030969 A1
(43) Pub. Date: Feb. 9, 2006

(54) Hand held OCR apparatus and method

(76) Inventors: Michael O. Norris, Colleyville, TX (US); Abdul H. Salemizadeh, Arlington, TX (US); Shahrom Kiani, Arlington, TX (US)

Correspondence Address: PHILIP G. MEYERS LAW OFFICE, 1009 LONG PRAIRIE ROAD, SUITE 300, FLOWER MOUND, TX, 75022, US

(21) Appl. No.: 11/243,315

(22) Filed: Oct. 3, 2005

Related U.S. Application Data
(62) Division of application No. 10/664,444, filed on Sep. 19, 2003.
(60) Provisional application No. 60/412,470, filed on Sep. 20, 2002.

(51) Int. Cl. G06F 7/00

(52) U.S. Cl. 700/215; 209/900

(57) ABSTRACT

A system is provided for the simple image capture and address recognition of mail, flats or parcels that does not require complex support or equipment and can be practiced on machinable and non-machinable mail pieces. The method described herein allows for further downstream processing of the scanned items by automated or manual mail or parcel systems. A simple OCR device can be used to read information on a piece of mail, flat or parcel using a hand held camera or fixed mounted camera. The image data is analyzed with OCR software or pattern recognition software, and a bar code label is printed representing the ZIP code or other relevant information and applied to the mail piece. A unique identification tag is printed on a label for those mail pieces captured but with no ZIP code results determined for later recall of the image and processing either on-line or off-line.

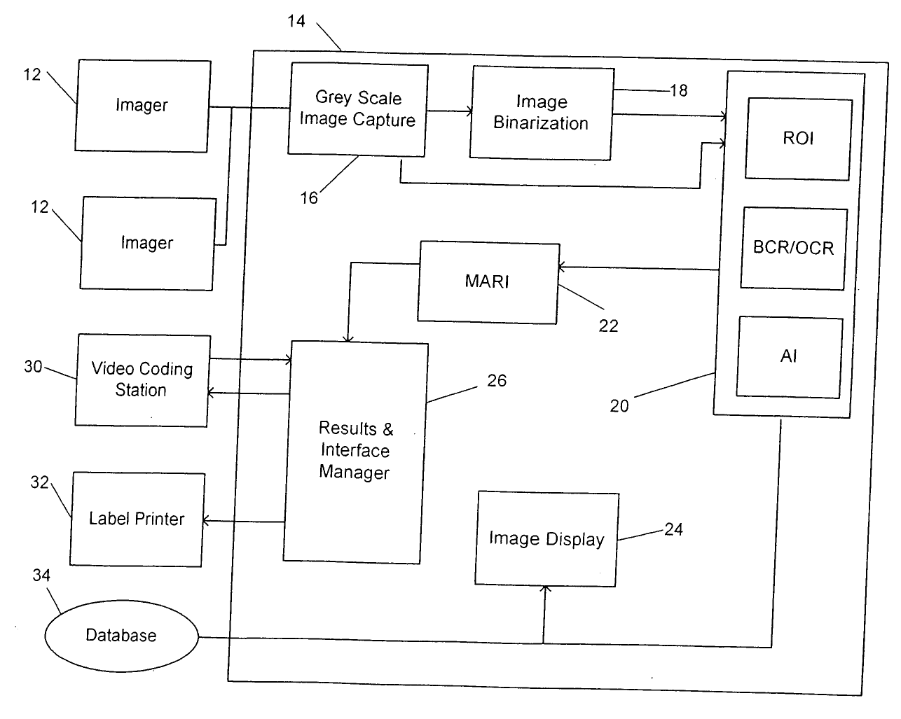

### RELATED APPLICATION

This application is a division of U.S. application Ser. No. 10/664,444, filed Sep. 19, 2003, which claims priority of U.S. Provisional Patent Application Ser. No. 60/412,470, filed Sep. 20, 2002.

### TECHNICAL FIELD

The invention relates to the field of information processing and, in particular, to the use of an optical character reader as an aid in sorting and processing machinable and non-machinable mail.

### BACKGROUND OF THE INVENTION

Present day mail and parcel scanning systems generally consist of large, fixed pieces of capital equipment. For processing letters and flats, these systems typically require that the letters and flats be properly oriented before the items are scanned for OCR readable address information, bar codes and other relevant information (certified mail, insured mail, etc). Once properly oriented, such mail pieces are scanned, and bar codes applied to the pieces which enable further downstream sorting by automated systems. For processing parcels, cameras may be positioned to capture one or all six sides of the parcel. Because of the large image represented by a parcel and the time required to process this image, a barcode that enables further downstream processing may not be applied to a parcel. In some cases, a tracking barcode may be applied and the resultant address information from the OCR processing can be stored in a file and later married up to the tracking barcode to enable further downstream processing.

Rejects from existing automated processes include mail pieces such as envelopes, flats, parcels and similar items that cannot be processed using automated machines and systems. Such mail pieces may include oversized pieces, overweight pieces, pieces with destination information in the wrong position on the mail piece, pieces with destination information partially or totally obscured, mail pieces with destination information in a form or format that cannot be scanned or interpreted by automated systems, and other mail pieces that for one reason or another cannot be processed with automated machines and systems. Rejects from currently employed automated processes are typically manually handled and sorted or cased. Manual processing of such mail pieces adds delay and expense to the overall process. Further, small mail rooms and/or postal facilities in remote areas typically have no means to scan address information and automatically generate appropriately formatted labels or other means of identification for further downstream processing in the automated mail or parcel streams.

U.S. Pat. No. 6,259,964 describes a manually operated mail sorting station that includes a case having numerous bins in which sorted mail will be placed during manual sorting at a post office. A hand-held optical scanner may be used to scan mail pieces that are then subsequently sorted to bins based on the results of the scan, such as by providing an indicator at each slot and lighting up the indicator for the slot that matches the results of the scan. The stated goal of the patent is to eliminate the need for the postal worker to memorize a sort scheme associated with the bins. The system described in U.S. Pat. No. 6,259,964 does not address the shortcomings alleviated through the use of the present invention.

### SUMMARY OF THE INVENTION

This invention provides an alternative system for the simple image capture and address recognition of mail, flats or parcels that does not require complex support or equipment and can be practiced on machinable and non-machinable mail pieces. It will be noted that “non-machinable” for purposes of the invention is a relative term and depends on the nature of the automated scanning system in use at the specific site.

The method described herein allows for further downstream processing of the scanned items by automated or manual mail or parcel systems. A simple OCR device can be used to read information on a piece of mail, flat or parcel using a hand held camera or fixed mounted camera. The image data is analyzed with OCR software or pattern recognition software, and a bar code label is printed representing the ZIP code or other relevant information and applied to the mail piece. A unique identification tag is printed on a label for those mail pieces captured but with no ZIP code results determined for later recall of the image and processing either on-line or off line.

One system according to the invention includes a computer and a hand-held imager connected to the computer which can be used to transmit an image of a mail piece to the computer. The computer includes computer coded logic for determining address data from the signal received from the hand-held imager, such as optical character recognition software coupled with software that compares the resulting read address with a zip code database. A label printer connected to the computer is used to print a postal bar code corresponding to an address identified by the means for determining address data, which can then be applied to the mail piece manually by a postal worker.

A method of processing a series of articles according to the invention includes the steps of:
(a) manually positioning an imager relative to each article so that the surface of the article with information thereon can be captured;
(b) then capturing the surface of the article with information thereon with the imager;
(c) using a computer to determine selected data from the signal received from the imager;
(d) using a computer to correlate the data to elements of a corresponding database; and
(e) taking an action in accordance with a processing scheme based on the results of steps (a)-(d). Such a method may be applied to a method of sorting mail pieces more specifically as the steps of:
(a) manually positioning an imager relative to each piece so that the surface of the mail piece with address information thereon can be captured;
(b) then capturing the surface of the mail piece with address information thereon with the imager;
(c) using a computer to determine address data from the signal received from the imager; and
(d) if an address is determined with sufficient specificity in step (c), taking an action in accordance with a postal processing scheme, which action is a first one of a series of events that will result in delivery of the mail piece to a destination point that corresponds to the scanned address.

According to a preferred form of the invention, the imager may be manually positioned relative to a mail piece so that the surface of the mail piece with address information thereon can be captured, and a computer used to determine address data from the signal received from the imager. This first, manually-executed step ensures that the address surface will be captured regardless of the size or shape of the mail piece. It should also be noted that the mailpiece may be in any orientation during the image capture process. If the computer determines the address with sufficient specificity, an action is taken in accordance with a postal processing scheme, the action being the first one of a series of events that will result in delivery of the mail piece to a destination point that corresponds to the captured address. In this regard, the action can be printing a postal bar code label for the mail piece corresponding to the address identified by the computer, followed by applying the bar code label to the mail piece and optionally re-introducing the manually labeled mail piece into the automated mail system such as in a second pass sort.

In the context of a federal postal process, a method of sorting a batch of mail pieces according to the invention includes the steps of sorting mail pieces from the batch using an automated sorting system that scans each mail piece and sorts it to a destination bin based on the results of the scan, and taking non-machinable mail pieces from the batch which cannot be sorted using the automated sorting system, or processing small volumes (relative to volumes processed on an automated system) of machinable mail and:
(a) manually positioning a scanner relative to each machinable or non-machinable mail piece so that the surface of each mail piece with address information thereon can be captured;
(b) then capturing the surface of each machinable or non-machinable mail piece with address information thereon with the imager;
(c) using a computer to determine address data from the signal received from the imager; and
(d) if an address is determined with sufficient specificity in step (c), taking an action in accordance with a postal processing scheme, which action is a first one of a series of events that will result in delivery of the mail piece to a destination point that corresponds to the captured address.

For purposes of the invention, a step of manually positioning the imager relative to a mail piece so that the surface of the mail piece with address information thereon can be captured should be understood to be as simple of positioning the imager over the address and activating a switch to activate the camera and light source. Alternatively, the imager could be mounted in a fixed frame and the mail piece positioned under the imager and the address information captured by activating the camera and light source with a foot switch that is connected in parallel with the switch in the imager.

If an address cannot be determined with sufficient specificity to permit a postal bar code label to be printed, the subsequent action can comprise the step of assigning and attaching an identification code to the mail piece and saving the image and identification code associated with the mail piece in a computer-accessible form for resolution at a later time. Preferably, the mail piece is labeled with the identification code in a machine scannable form, or the identification code is an existing feature that appears on the mail piece that can be identified when re-captured. The mail piece image is then put through a video coding procedure which includes the steps of displaying the image associated with the appropriate identification code on a video screen, and manually entering address information associated with the displayed mail piece into a video coding computer. With the imager, the identification code can be captured and read from the mail piece, with the postal delivery barcode printed from the label printer and then applied to the mail piece, which bar code corresponds to the address information entered into the video coding computer.

The invention provides a flexible system that may be utilized in a stand alone operation or be integrated with an automated system. As a stand-alone system, this method can provide a means to prepare items for further processing by automated equipment. As part of an automated system, the method of the invention can provide an intake point to accommodate items that require manual handling which allows for scanning of any size or shape item, and does not require the item to be oriented in any special way.

### BRIEF DESCRIPTION OF THE DRAWING

The drawing FIGURE is a schematic representation of the architecture of a coding system in accordance with the invention.

### DETAILED DESCRIPTION OF THE INVENTION

Turning to the drawing, a system according to the invention includes one or more imagers 12 connected to a computer 14. Imager 12 may be a hand held optical capture device or a stationary unit configured such that an operator may position a mail piece under the unit to capture information appearing on the mail piece into computer 14. Database 34 is a correlation/validation database.

An item to be read can be of any size or shape. The operator places the item either under an approved frame/capture system, or positions a hand held imager over the region of interest. In the latter case, operator selection of the region of interest can aid the ROI logic in computer 14. A visual indicator assists the operator of the hand held imager 12 in selecting the region of interest. The item is then captured by hand actuating a trigger switch. An audible and/or a visual signal are presented to the operator to confirm that the image has been successfully captured. The signal from imager 12 may be transmitted to computer 14 through a connecting cable or via a wireless connection.

Resident on computer 14 are grey scale image capture software 16, image binarization software 18, an image analysis software module 20 that includes region of interest determination software (ROI), bar code recognition software (BCR), optical character recognition software (OCR) and address interpretation (AI) software. Also resident on computer 14 are a Multiple Address Reader Interface module (MARI) 22, an optional image display module 24 and a results and interface manager module 26. These software functions may be used in any convenient form, for example, as a single program with various functional subroutines, or as separate programs that pass data between them as described hereafter.

In operation, information captured with hand held imager 12 is transmitted to computer 14. The gray scale image is transmitted to binarization module 18 which converts the image to binary form. The binary image data is then processed by software module 20, which identifies one or more regions of interest within the binary image, typically an address block or portion of an address block. Optical character recognition and/or bar code recognition software included in module 20 then processes the information in the region of interest in an attempt to translate or resolve the information.

Image analysis module 20 can provide for character recognition, address interpretation, bar code detection and decoding, and endorsement line detection and recognition and pattern recognition. Module 20 transfers the analyzed image data to results and interface manager 26, which determines if the results are suitable for ZIP code determination and informational database requirements, or requires further processing, such as re-capture or video coding. Valid results as determined by results and interface manager 26 are sent in a coded format to label printer 32.

The type of bar code printed is dependent upon the image analysis module 20 and results analyzer 26 reaching a determination of the address and corresponding ZIP code or other relevant information. Any item scanned that is determined by the OCR application to have correlated zip code information would have the appropriate bar code applied to a label. For any item not analyzed by the OCR application, the printer 32 can print a unique identification bar code printed on a label for manual application to the item scanned.

When the image data cannot be resolved and/or results and interface manger 26 determines that destination information for a particular mail piece is not sufficient for ZIP code determination, the unresolved image data is transmitted to a video coding station 30 along with a unique item identifying code. The image data is displayed for resolution by a human operator who manually inputs all or part of the information contained in the image which can then be transmitted back to the results and interface manager 26.

One feature of module 20 is an address interpreter (AI) which interfaces with a national database of valid addresses. The address interpreter software, in conjunction with database module 34, is capable of matching partial address information against the national address database to identify a given destination address with only a partial address, whereby unresolved address information for a given mail piece may be resolved. Further, if this matching process is done on a real time basis, computer 14 can complete a partial address or resolve an address which is complete but incorrect (for example, address and zip code as read by OCR are legible but do not match.) This would avoid the need for manual video coding in such situations.

Once the address information is resolved, results analyzer 26 transmits a signal to label printer 32 which prints an identifying label which is attached to the mail piece. The identifying label may be printed with a postal bar code and/or an item identification number which is stored in the results and interface manager module 26 for subsequent processing of the mail piece. If an address cannot be determined with sufficient specificity to permit a postal bar code label to be printed, and the image data cannot be resolved on a real time basis by computer 14, the identification number assigned to the mail piece is printed on the label. The identification number is saved along with the image data for the mail piece for resolution at a later time. Thus, the type of code printed on the label is dependent upon the OCR application reaching a determination of the address and corresponding ZIP code or other relevant information. Any item scanned that is determined by the OCR application to have correlated information would have the appropriate bar code applied to a label. Any item not analyzed or resolved by the OCR software will have a unique identification bar code printed on a label for application to the item. In the event that an existing identification or tracking number is resolved from a bar or similar code already existing on the surface of the item to be analyzed, the existing tracking number may be stored and utilized for downstream processing.

In order to display processed image information locally, a software module 24 can be provided. As illustrated, the processed image, along with the grayscale image and the results of the OCR and/or BCR analysis, are also transmitted to a local or remote database 34 for storage and subsequent use.

As will be appreciated, system can be utilized as part of an induction system feeding an automated system in which the system may be used to apply bar codes at any input point within the distribution process. The system may be used in conjunction with an automated processing system for reject processing, that is, processing mail pieces that for one reason or another, cannot be processed by the particular system. The system may be utilized at a postal center service counter to process mail pieces on an as received basis and/or in connection with processing returned items.

Various options are possible using the system and method of the invention. The collection of address data can occur anywhere in a distribution process. The method of the invention could be used at point of sale locations, centralized distribution centers, or a variety of other locales. Additionally, as noted above, unresolved items with identification tags may be presented at a later time for processing. When the mail piece's identification tag is captured and read, results and interface manager 26 queries the results stored and returns the mail piece's ZIP code or data result for printing on a label, which can then be manually applied to the mail piece. This allows for further processing by automated systems.

Data results from an unresolved item's ZIP code may be made available from the results and interface manager 26. The step of manually applying a bar code is not required if processing equipment downstream can access the identification code, retrieve the ZIP code or data results, and process the item based on these results.

The system of the invention can be operated remotely from a central facility. For example, a route driver in a truck or vehicle can capture items received and apply bar codes containing either ZIP codes or identification tags. Unresolved images can be stored on the vehicle's computer or sent via digital data link to the central facility. When the truck arrives at the central facility, the items with identification tags are then captured and read, and the results are available immediately if the data was sent via the data link, or available some time later if the images were stored on the vehicle's computer.

The operator has the option of capturing a single image on one part of a surface, or multiple images on different locations of the same media to be captured. A single result record may be generated from multiple image captures. This allows the operator the ability to capture images on the front and back of an envelope or flat, or multiple areas on the same surface of an envelope or flat. For parcels, the operator may capture multiple labels on any area of the surface and any of six sides of the media to be read. All information captured can be entered into a single data record for that media.

For returns processing, the return address can be decoded. Any bar codes associated with the media, such as insurance, certified, and confirmation bar codes, can be tied to that media's data record. Information contained in data records generated according to the invention can be used to automatically populate fields in an automated form.

The process of the invention allows the orientation of the scanned data to be omni-directional in relation to the image capture device. The application software then orients the data captured. A process of the invention can also validate captured image addresses against a national or local change of address database. The captured addressee and address is located and compared to a change of address database. If a move is indicated, the new address is associated with the captured image data. A means to print a new address label or bar code containing the new move ZIP data is provided.

The process of the invention can be used to capture a wide variety of non-machinable items (items not suited for automated processing). Items captured in this process will have selected images lifted by a hand held capture device as described in the above claims. The user will have the ability to collect selected image information, determine ZIP data and apply the appropriate label for later processing. This labeling process could involve the placement of an address label, bar code label, or unique identification tag label. It should be noted that non-machinable items or mail pieces according to the invention may include a variety of different kinds of items, including items that are rejects from automated sorting (correct size but unreadable) as well as items that cannot be fed into the automated scanning and sorting machine due to their physical characteristics.

Image recognition results are not limited to address information and ZIP codes. The invention can be applied to a variety of applications involving the reading of character information. To ensure accuracy of the read data, correlation data may be stored in a correlating database. A database can be created to contain valid character combinations or codes with check digits to reduce errors. Recognition results may include but not be limited to class of service, purchase order number, invoice number, return to sender data, return address, weight, store number, box number of X of Y amount of boxes, and other human readable characters. The resulting information is available for (but not limited to) use in invoicing, marketing, route planning, tracking, distribution processing, etc. Similarly, bar code recognition results are not limited to address information and ZIP bar codes. Any bar code contained on the media may be decoded.

The process of the invention can incorporate software that recognizes patterns in the captured image. These patterns could be company logos or other forms of indicia that have an associated return address. This data is compared to a database that contains rules for association and actions to be taken based upon conditions, for example, return to sender. Thus, whenever a certain company logo is identified, an action such as return to sender is taken.

Image analysis software used in the invention can have the capability to recognize symbols, and be capable of synthesizing the information for input into a data record, part of a bar code, or human readable characters. Examples of these symbols are but are not limited to, indicia, hazardous material warning symbols, return to sender marks such as a finger, and company logos.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is, therefore, intended that the appended claims encompass any such modifications or embodiments.

1. A method of sorting a batch of mail pieces, comprising:
sorting machinable mail pieces from the batch using an automated sorting machine that scans each mail piece and sorts it to a destination bin based on the results of the scan;
taking non-machinable mail pieces from the batch which cannot be sorted using the automated sorting system;
for each such non-machinable mail piece, selecting a region of interest on a side of each non-machinable mail piece before scanning the non-machinable mail piece, the region of interest including a destination address for the mail piece;
manually positioning at least one of an imager and the mail piece such that the imager is directed toward the region of interest;
capturing an image of the region of interest with the destination information therein with the imager;
transmitting a signal including image data representing the captured image to a computer;
using the computer to process the captured image data to determine a destination address for the mail piece;
determining a postal zip code corresponding to the destination address; and
then applying a code to the mail piece that represents the postal zip code corresponding to the destination address.

2. The method of claim 1, further comprising the step of generating one of an audible and visual signal, the signal indicating that the image was successfully captured.

3. The method of claim 3, wherein the step of capturing an image of the region of interest with the destination information therein with the imager further comprises capturing an image including the region of interest but less than the side of the mail piece oriented toward the imager.

4. The method of claim 1 wherein the step of using the computer to process the captured image data to determine a destination address for the mail piece further comprises using a computer implemented address interpreter that interfaces with a national address database for matching partial address information from a mail piece with valid destination addresses.

5. The method of claim 1, wherein the step of capturing an image of the region of interest with the destination information therein with the imager further comprises displaying image data captured from the mail piece.

6. The method of claim 1, wherein the step of applying a code representing the postal zip code corresponding to the destination address further comprises printing a postal bar code label for the mail piece and applying the bar code label to the mail piece

7. The method of claim 1, further comprising:
assigning an identification code to the mail piece if an address cannot be determined with sufficient specificity;
saving the image and identification code associated therewith in a computer accessible form for resolution at a later time; and
applying the identification code to the mail piece.

8. The method of claim 7, further comprising:
displaying the image associated with identification code on a video screen;
manually entering address information associated with the displayed mail piece into a video coding computer; and
applying a postal delivery bar code to the mail piece, which bar code corresponds to the address information entered into the video coding computer.

9. The method of claim 1, wherein the imager is a hand-held capture device.

10. The method of claim 1, wherein the imager is in a fixed position and wherein the mail piece is manually positioned by an operator such that the imager captures an image of the region of interest.

11. The method of claim 1, wherein the code applied to the mail piece is a bar code.

12. The method of claim 7, wherein the code applied to the mail piece and the identification code are bar codes.
